(19) United States
(12) Patent Application Publication
(10) Pub. No.: US 2023/0099464 A1
(43) Pub. Date: Mar. 30, 2023

(54) SYSTEMS AND METHODS FOR TRANSMITTING INTER-VEHICLE COMMUNICATIONS TO FACILITATE TRAFFIC FLOW

(71) Applicant: Loc Van Nguyen, Houston, TX (US)

(72) Inventor: Loc Van Nguyen, Houston, TX (US)

(21) Appl. No.: 17/956,149

(22) Filed: Sep. 29, 2022

Related U.S. Application Data
(60) Provisional application No. 63/249,954, filed on Sep. 29, 2021.

(51) Int. Cl. G08G 1/0962; G06F 3/16; G08G 1/0968

(52) U.S. Cl. CPC G08G 1/09626; G06F 3/167; G08G 1/096855

(57) ABSTRACT

The disclosure provides for systems and methods for communicating messages from one vehicle to another vehicle. An input device, such as a cell phone, can be configured to generate and transmit a signal that corresponds with a message to an output device for display of messages. The messages can be displayed in a rearward direction, allowing drivers to communicate with vehicles located behind them on a roadway.

### CROSS-REFERENCE TO RELATED APPLICATIONS

The present application claims the benefit of U.S. Provisional Patent Application No. 63/249,954, filed on Sep. 29, 2021, and entitled “Systems and Methods for Transmitting Inter-Vehicle Communications to Facilitate Traffic Flow,” the entirety of which is incorporated herein by reference and made a part of the present disclosure.

### FIELD

The present disclosure relates to systems for transmitting communications between vehicles to facilitate traffic flow, and to methods of making and using the same.

### BACKGROUND

Safe traffic flow is important to developed countries having modern road systems. Many aspects of traffic flow are governed by laws and regulations, at least some of which are designed to increase the safety of roadway traffic. For example, most, if not all, states within the United States have laws or regulations designed to prevent vehicles from passing a bus (e.g., a school bus) when the bus is stopped on the roadway to pick-up and drop-off a passenger (e.g., a student). Such laws or regulations often require vehicles to remain a minimum safe distance from the bus. Sometimes, vehicles on both sides of the road (e.g., a two-way road) are required to stop when the bus is stopped. Vehicles in the same lane as the bus are also required stop at a safe distance.

While many such laws and regulations prescribe such behaviors, the implementation of such laws and regulations often require, in addition to sanctions for violations, a learned “culture” of drivers that are compliant to, yielding to, and facilitating of such safe traffic habits. Thus, the habitual actions of drivers affect safe traffic flow. For example, many drivers utilize gestures, such as hand and facial gestures, to communicate with other drivers during traffic flow. One example is where one driver will express “thanks” to another driver (e.g., for allowing a lane change) by waving, giving a thumbs-up, or nodding (e.g., nodding through the rearview mirror). While such gestures do facilitate an accommodating traffic culture, they often require the driver to remove their attention from the immediate task of piloting the vehicle, such as be removing their hands from the wheel and/or their eyes from the road.

### BRIEF SUMMARY

Some embodiments of the present disclosure include an inter-vehicle communication system for communicating messages from one vehicle to other vehicles. The system includes a display configured to be positioned on a vehicle to present a message directed rearward of the vehicle. The message that the display is configured to present is a traffic-related communication.

Some embodiments of the present disclosure a system for communicating messages to other vehicles. The system includes a vehicle and a display on the vehicle. The display is positioned to present a message directed rearward of the vehicle. The message that the display is configured to present is a traffic-related communication.

Some embodiments of the present disclosure a traffic system configured for inter-vehicular communication. The traffic system includes a plurality of vehicles. At least one of the vehicles is a vehicle that includes a display positioned to present a message directed rearward of the vehicle. The message that the display is configured to present is a traffic-related communication.

Some embodiments of the present disclosure a method of inter-vehicular communication. The method includes, while in a first vehicle that is on a roadway, displaying a message on a display of the first vehicle. Displaying the message includes presenting the message in a rearward direction from the first vehicle for view by a driver of a second vehicle on the roadway. Presenting the message includes presenting a traffic-related communication.

Some embodiments of the present disclosure include a vehicle communication system for communicating a message from one vehicle to another vehicle. The system includes an input device configured to generate and transmit a signal that corresponds with a message, and an output device configured to receive the signal. The output device includes a display configured to present the message in response to receipt of the signal.

Some embodiments of the present disclosure include a vehicle having a communication system for communicating a message from the vehicle to another vehicle. The vehicle includes an input device configured to generate and transmit a signal that corresponds with a message, and an output device configured to receive the signal. The output device includes a display configured to present the message in response to receipt of the signal. The display is positioned on the vehicle to present the message in a rearward direction from the vehicle.

Some embodiments of the present disclosure include a method. The method includes displaying a message on a display of an output device. The display is on a first vehicle on a roadway, and is positioned to present the message in a rearward direction from the first vehicle toward a second vehicle on the roadway.

### BRIEF DESCRIPTION OF THE DRAWINGS

So that the manner in which the features of the compositions, articles, systems and methods of the present disclosure may be understood in more detail, a more particular description briefly summarized above may be had by reference to the embodiments thereof which are illustrated in the appended drawings that form a part of this specification. It is to be noted, however, that the drawings illustrate only various exemplary embodiments and are therefore not to be considered limiting of the disclosed concepts as it may include other effective embodiments as well.

FIG. 1 is a simplified schematic of a system in accordance with some embodiments of the present disclosure.

FIG. 2A depicts a first vehicle preparing to make a lane change in front of a second vehicle.

FIG. 2B depicts the first vehicle of FIG. 2A, after making the lane change, displaying a communication to the second vehicle in accordance with some embodiments of the present disclosure.

FIG. 2C is a detail view of a portion if FIG. 2B showing a driver using the inter-vehicle communication system in accordance with some embodiments of the present disclosure.

FIG. 2D is a detail view of a portion of FIG. 2B showing the presentation of a message with the inter-vehicle communication system in accordance with some embodiments of the present disclosure.

### DETAILED DESCRIPTION

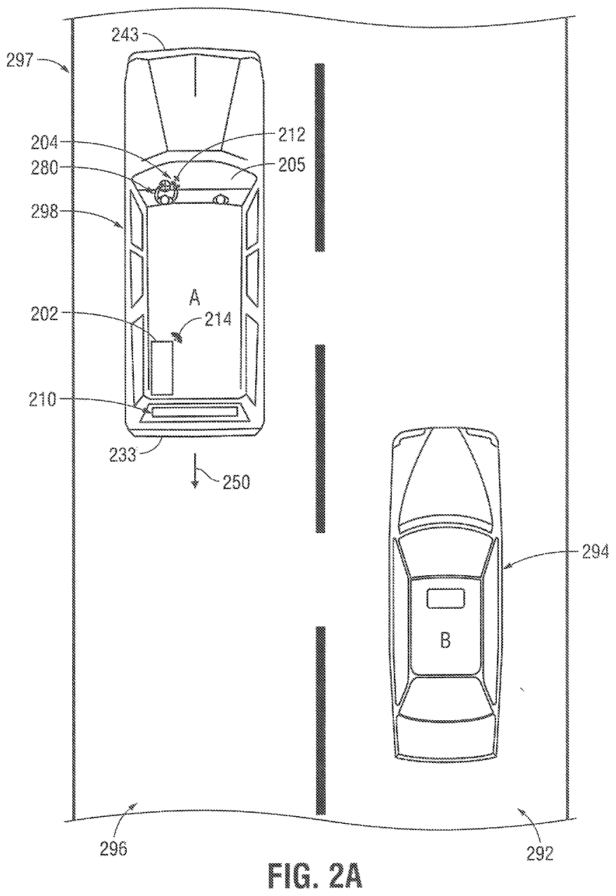

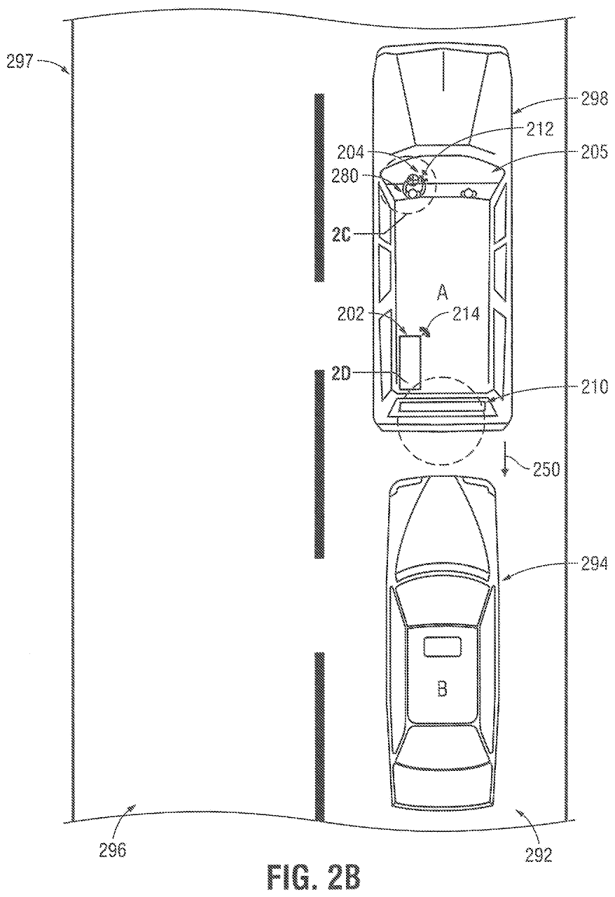

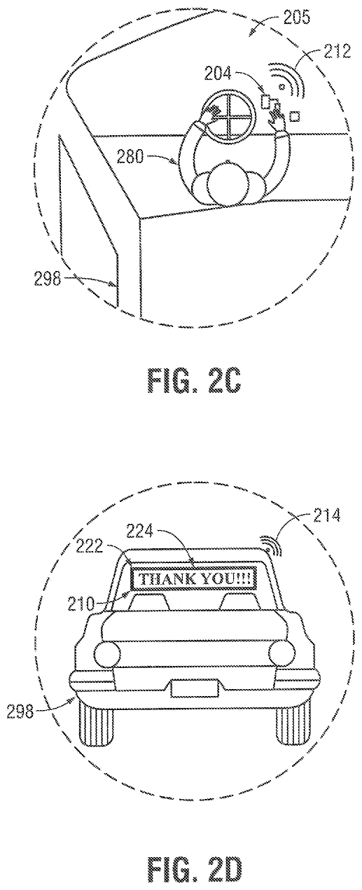

The present disclosure includes systems and methods for facilitating inter-vehicle communications between vehicles, such as during traffic. The present disclosure includes inter-vehicle communication systems and methods for communicating messages from one vehicle to other vehicles. The inter-vehicle communication systems include a display positioned on, or configured to be positioned on, a vehicle to present a message directed rearward of the vehicle. As used herein “rearward” of a vehicle refers to a direction on or along the vehicle that corresponds with a rear of the vehicle and a direction of the vehicle if the vehicle were traveling in reverse. For example, with reference to FIG. 2A, the rearward side 233 of the vehicle 298 is near the rear windshield and rear bumper of the vehicle 298, and opposite the frontward side 243 of the vehicle 298. The present disclosure also includes vehicles having the inter-vehicle communication systems incorporated therein. The present disclosure also includes a traffic system configured for inter-vehicular communication that includes a plurality of vehicles, with at least one of the vehicles having an inter-vehicle communication system incorporated therein.

### Systems for Inter-Vehicle Communications

Some embodiments include a system for transmitting a communication from one vehicle to another vehicle. The inter-vehicle communication system can be used in various vehicles, such as cars, trucks, semi-trailer trucks, vans, and buses. In some embodiments, the vehicles are civilian vehicles. In other embodiments, the vehicles are first response and/or emergency vehicles, such as police vehicles, fire trucks, or ambulances. Generally, the inter-vehicle communication systems disclosed herein are capable of displaying user-prompted communications for viewing by others. For example, a user in one vehicle can prompt the inter-vehicle communication system to display a communication to a person in another vehicle. As will become more evident from the following discussion with reference to the Figures, the inter-vehicle communication system can be used to communicate various messages that can facilitate a safe and cordial traffic system.

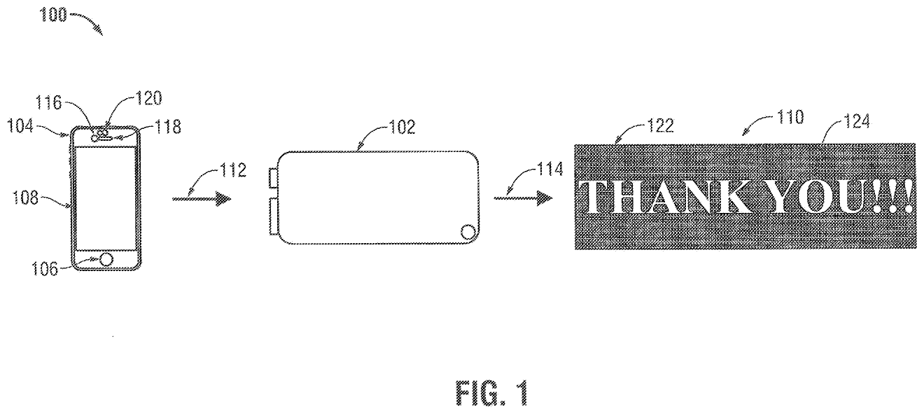

With reference to FIG. 1, inter-vehicle communication system 100 is depicted. Inter-vehicle communication system 100 includes central controller 102, input device 104, and output device 110.

Input device 104 is a device configured to generate and/or transmit input signals related to and/or defining a message that is to be communicated using the inter-vehicle communication system 100. In the embodiment depicted in FIG. 1, input device 104 is configured to generate and transmit input signals 112 to central controller 102. For example, and without limitation, input device 104 may be or include a computer or a programmed logic controller (PLC). Input device 104 may include a central processing unit (CPU), a data storage (e.g., a hard drive), a graphical user interface (GUI), a receiver for receipt of input signals, and a transmitter for transmission of output signals. In some embodiments, the input devices disclosed herein are or include a smart phone, tablet computer, a user interface and/or navigation system that is integrated into a vehicle, or a smart watch. As shown in FIG. 1, input device 104 is a smart phone. Input device 104 includes control button 106, display or touchscreen 108, microphone 116, speaker 118, and camera 120. In operation, a user may operate input device 104 to generate and/or transmit the desired input signal 112 to central controller 102. For example, a user can operate and/or control input device 104 using control button 106 and/or display or touchscreen 108 and/or microphone 116. The display or touchscreen 108 may present a GUI that users can interact with to control input device 104. In some embodiments, a user can operate and/or control input device 104 via voice activation using microphone 116. In some embodiments, the input device 104 includes a software application (App) thereon. The software application may be configured present a GUI to the user, allowing the user to control the generation and/or transmission of input signals from the input device 104. For example, the software application can be an App that is downloaded onto a user's smart phone or other device. In some embodiments, the input device disclosed herein is integrated into a vehicle. For example, the input device may be integrated into a navigation system or other user interface of a vehicle, such that a user interacts with the navigation system of the vehicle to generate and/or transmit input signals. Interaction with the navigation system of the vehicle may be hand and/or voice actuated.

Central controller 102 can be a device configured to receive input signals 112, process input signals 112, and transmit output signals 114. For example, and without limitation, central controller 102 may be or include a computer, a programmed logic controller (PLC), or a control platform. Central controller 102 may include a central processing unit (CPU), a data storage (e.g., a hard drive), a receiver for receipt of input signals, and a transmitter for transmission of output signals. In some embodiments, central controller 102 and input device 104 are in direct communication, such that no intermediate devices receive, process, and/or transmit input signal 112 between input device 104 and central controller 102. In other embodiments, central controller 102 and input device 104 are in indirect communication, such that an intermediate device receives, processes, and/or transmits input signal 112 between input device 104 and central controller 102. For example, input device 104 and central controller 102 may be in indirect communication via a host computer system, such as a computer system that facilitates operation and/or execution of the App or components thereof. In such embodiments, input signal 112 is transmitted from input device to the host computer. The host computer may receive, optionally process, and then transmit input signal 112 to central controller 102. In some embodiments, the host computer functions as the central controller, such that the host computer processes the input signal 112 to form the output signal 114, and transmits the output signal 114 to the output device 110. In some embodiments, the input device 104, central controller 102, and/or output device 110 are in communication via a Cloud computing system, such as through iCloud. For example, one or more components of the App may be hosted on a Cloud computing system, such that generation and/or transmission of the input signal 112 and/or output signal 114 may executed via the Cloud computing system. In some embodiments, the central controller disclosed herein is integrated into a vehicle. For example, the central controller may be integrated into the navigation system of a vehicle. In some embodiments, the central controller and the input device are the same component. For example, a smart phone or navigation system may function as both the input device and the central controller.

Output device 110 is a device configured to receive and display communications that correspond with output signals 114 from central controller 102 and/or input device 104. For example, and without limitation, output device 110 may be or include a display 122, such as a light emitting diode (LED) display. In some embodiments, the output device disclosed herein is integrated into a vehicle. For example, the output device may be integrated into the rear windshield of a vehicle. In some embodiments, the output device is attached to the vehicle (e.g., to the rear windshield). In some embodiments, at least a portion of the rear windshield is or functions as a display screen to display the messages disclosed herein.

In the embodiment shown in FIG. 1, output device 110 includes an LED matrix display 122. Output device 110 may include a receiver for receipt of output signals 114 and a processor for processing the output signals 114 to cause display 122 to display a message 124 that corresponds with the output signal 114. For example, as shown in FIG. 1, the message 124 is “THANK YOU!!!” While the message 124 is “THANK YOU!!!,” the systems and methods disclosed herein are not limited to displaying this particular message and may display other textual messages. For example, and without limitation, other exemplary textual messages that may be displayed include “You are welcome,” “I need to change lanes,” “I am taking a left,” “I am taking a right,” “Sony,” “Stop,” and “May I pass you.” These are only examples, and do not limit the messages that may be displayed by the systems and methods disclosed herein. Furthermore, while the message 124 is shown as a textual message, the systems and methods disclosed herein are not limited to displaying textual messages, and may display images or graphics, such as emojis, pictures, or other visual displays. For example, and without limitation, the message displayed may be or include a graphic of a “thumbs-up” hand gesture or another hand gesture. In some embodiments, the output device 110 can output an audio signal (e.g., an audio signal of “Thank you”). The messages disclosed herein may be in the form of a directive or command, a question, a statement, or an exclamation. The messages can be in the form of an expression of gratitude (e.g., “Thank You”), an expression of future intentions (e.g., “I am going to change lanes”), an expression of current status (e.g., “I am on my way to a hospital”), an expression of warning (e.g., “Hazard Ahead”), or another expression.

In some embodiments, output device 110 is in direct communication with central controller 102, such that no intermediate devices receive, process, and/or transmit output signal 114 between central controller 102 and output device 110. In some embodiments, output device 110 is in direct communication with input device 104, such that input device 104 generates and transmits output signal 114 (e.g., signal 112 and signal 114 can be the same signal) and such that no intermediate devices receive, process, and/or transmit output signal 114 between input device 104 and output device 110. In other embodiments, output device 110 is in indirect communication with central controller 102 and/or input device 104, such that an intermediate device receives, processes, and/or transmits input signal 112 and/or output signal 114. For example, output device 110, input device 104, and/or central controller 102 may be in indirect communication via a host computer system, as described above.

In some embodiments, the input device 104 and central controller 102 are in communication with one another via wired communication (e.g., USB, ethernet), wireless communication (e.g., WIFI, Bluetooth, cellular), or combinations thereof. In some embodiments, the output device 110 and central controller 102 are in communication with one another via wired communication (e.g., USB, ethernet), wireless communication (e.g., WIFI, Bluetooth, cellular), or combinations thereof. In some embodiments, the output device 110 and input device 104 are in communication with one another via wired communication (e.g., USB, ethernet), wireless communication (e.g., WIFI, Bluetooth, cellular), or combinations thereof.

While the input device 104, central controller 102, and output device 110 are shown as separate components, in some embodiments, one or more of the input device 104, central controller 102, and output device 110 are integrated into a single component. For example, a single component may provide the functionality of both the input device 104 and central controller 102. In one example, a user's smart phone may be configured to transmit an output signal directly to the output device 110, without requiring an intermediate central controller to process the signal. In another example, a single component may provide the functionality of both the output device 110 and central controller 102. In one such example, an LED display and central controller may be an integrated unit that is configured to receive signals from an input device and display the message in response to the signals. In another example, a single component may provide the functionality of the input device 104, output device 110, and central controller 102. For example, a user interface in a vehicle (e.g., a computer system integrated into the vehicle) may be configured to generate and display a message.

### Methods of Inter-Vehicle Communication

Some embodiments include a method of inter-vehicular communication. The method can include, while in a first vehicle that is on a roadway, displaying a message on a display of the first vehicle. Displaying the message can include presenting the message in a rearward direction from the first vehicle for view by a driver of a second vehicle on the roadway. Presenting the message can include presenting a traffic-related communication to other drivers on the roadway.

In one exemplary operation of inter-vehicle communication system 100, a user in a first vehicle that has just been allowed, by a driver in a second vehicle, to change lanes into a position in front of the second vehicle may desire to thank the driver in the second vehicle. The user may command input device 104 to generate and/or transmit an input signal 112 that corresponds with the display of the message 124 (i.e., “THANK YOU!!!”). For example, the user may push control button 106, touch screen 108, and/or voice activate input device 104 using microphone 116. In some embodiments, input device 104 is configured for voice-to-text recognition, such that a user may verbalize a custom message, and the display 122 displays the custom message. In some embodiments, the inter-vehicle communication system 100 has multiple pre-determined messages that a user can select from, such as “Thank You.” In response to the user, the input device 104 may generate an input signal 112 that corresponds with the message 124 and transmit the input signal 112 to the central controller 102. The central controller 102 may receive the input signal 112 and process the input signal 112 to generate an output signal 114 that corresponds with the display of the message 124 (i.e., “THANK YOU!!!”). The output signal 114 may be a signal and/or data configured to control the message that is displayed on display 122. The central controller 102 then transmits the output signal 114 to the output device 110. The output device 110 receives the output signal 114 and displays the message 124 in response to the output signal 114. For example, the output device 110 converts the digital data of output signal 114 into the message 124.

With reference to FIGS. 2A-2D, operation of the inter-vehicle communication system in one exemplary traffic scenario is described. As shown in FIG. 2A, first vehicle 298 is in lane 296 of roadway 297, and second vehicle 294 is in lane 292 of roadway 297. First vehicle 298 has an inter-vehicle communication system incorporated therein, including input device 204, output device 210, and central controller 202. In the traffic scenario of FIG. 2A, the driver 280 of first vehicle 298 wants to change lanes, from lane 296 to lane 292, to be in front of second vehicle 294.

In the exemplary traffic scenario of FIGS. 2A-2D, FIG. 2B is temporally after FIG. 2A. As shown in FIG. 2B, second vehicle 294 has allowed first vehicle 298 to change lanes, from lane 296 to lane 292, to be in front of second vehicle 294.

In some embodiments, the inter-vehicle communication system disclosed herein is incorporated and/or integrated into a vehicle. The inter-vehicle communication system may be an additional component added to the vehicle (e.g., and “after-market” install) or may be integrated into the vehicle as a pre-installed component of the vehicle. Input device 204 is mounted on a dashboard 205 of first vehicle 298 in close proximity to driver 280, such that driver 280 can readily control input device 204 via hand controls and/or voice activation. Central controller 202 is mounted within first vehicle 298. Output device 210 is mounted at the rear of the first vehicle 298, such that display 222 faces vehicles behind first vehicle 298 for display of messages 224 thereto. That is, the display 222 is positioned to direct messages 224 in a rearward direction 250 from first vehicle 298.

In the traffic scenario of FIG. 2B, driver 280 desires to thank the driver of the second vehicle 294 for allowing the first vehicle 298 to change lanes. To do so, driver 280 commands input device 204 through hand and/or voice-activated controls, to transmit an input signal 212 to central controller 202 that corresponds with the message 224 of “THANK YOU!!!” The central controller 202 then transmits an output signal 214 to output device 210 that corresponds with the message 224 of “THANK YOU!!!” The output device 210 then displays the message 224 “THANK YOU!!!” on display 222. The display 222 is positioned within and/or on first vehicle 298 such that message 224 is projected in the rearward direction 250 and is clearly visible to the driver of the second vehicle 294.

Thus, using the systems and methods disclosed herein, after a successful lane change, a driver of a vehicle is capable of thanking a driver of another vehicle that allowed for the lane change. The inter-vehicle communication system disclosed herein provides an ability to drivers to implement a culture of yielding. The inter-vehicle communication system disclosed herein allows drivers to quickly and safely transmit a message to another vehicle without having to waive, give a thumbs-up, or look into the rearview mirror. Thus, the inter-vehicle communication system provides drivers with a safer way to communicate with other drivers, by allowing the driver to keep their hands on the steering wheel for longer and eyes on the road for longer (e.g., pushing a button on a smart phone can be performed more quickly than may hand gestures that must be directed to a particular driver). In some embodiments, where the message is voice-activated, the driver can send the message while keeping their hands on the wheel and eyes on the road without interruption. Thus, use of the inter-vehicle communication system can increase roadway safety by allowing drivers to focus on driving the vehicle rather than having to perform gestures to express gratitude. While described as used to display messages after a lane change, the systems and methods disclosed herein are not limited to this particular use, and may be used to display messages in other traffic scenarios. In some embodiments, prior to changing lanes, the driver 280 of the first vehicle 298 can cause the display 222 to display a message to the second vehicle 294 communicating to the driver of the second vehicle that the first vehicle 298 would like to change lanes in front of the second vehicle 294. For example, the message can read “Lane Change 4” or any other message that communicates the desire to change lanes.

While the inter-vehicle communication system disclosed herein is shown as including devices that are external to the car, such as the input device being the user's smart phone, the systems and methods disclosed herein are not limited to this particular embodiment. For example, one or more of the input device, central controller, and output device may be an integral component of the vehicle. For example, the input device may include buttons and/or a touchscreen of the vehicle. Many vehicles have smart device graphical user interface incorporated therein, such as Apple Car Play, which may function as the input device. In some embodiments, the input device is an integral component of a vehicles navigation system.

In some embodiments, the inter-vehicle communication system disclosed herein is incorporated and/or integrated into a self-driving car. In some such embodiments, the generation of the messages displayed by the inter-vehicle communication system can be initiated by a person within the car in the same or similar manner as described in reference to FIGS. 2A-2D. In other such embodiments, the generation of the messages displayed by the inter-vehicle communication system can be initiated by the self-driving car. For example, an onboard computer system of the self-driving car, which may include artificial intelligence features, may determine that a lane change or other action is needed, and may generate a message that corresponds with that needed action.

### Exemplary Uses of the Inter-Vehicle Communication System

The inter-vehicle communication system is configured to communication traffic-related communications to other vehicles. As used herein, a “traffic-related communication” is a message that communicates information regarding the traffic on the road system that the vehicle transmitting the message is travelling, including information regarding the current status of traffic, an expected future status of traffic, or the past status of traffic. For example, an exemplary message communicating information regarding the current status of traffic is one stating “Traffic jam ahead;” an exemplary message communicating information regarding an expected future status of traffic is one stating “Lane change 4;” and an exemplary message communicating information regarding a past status of traffic is one stating “Thank you” (e.g., for previously letting a vehicle change lanes).

Example 1—In a first example, a user can use the inter-vehicle communication system to communicate gratitude to another driver (in the same or similar manner as discussed in reference to FIGS. 2A-2D) to thank a driver for allowing you to change lanes in front of their vehicle. The message can be, for example, “Thank you.”

Example 2—In a second example, a user can use the inter-vehicle communication system to communicate to another driver that the user will soon change lanes. The message can be, for example, “Lane change →” or “← Lane change.”

Example 3—In a third example, a user can use the inter-vehicle communication system to communicate to another driver that the user will soon brake. The message can be, for example, “Braking.”

Example 4—In a fourth example, a user can use the inter-vehicle communication system to communicate to another driver that the user will soon exit. The message can be, for example, “Exiting.”

Example 5—In a fifth example, a user can use the inter-vehicle communication system to communicate to another driver that the user will soon turn. The message can be, for example, “Turning →” or “← Turning.”

Example 6—In a sixth example, a user can use the inter-vehicle communication system to communicate to another driver that the user will soon slow down. The message can be, for example, “Slowing down.”

Example 7—In a seventh example, a user can use the inter-vehicle communication system to communicate to another driver the presence of a hazard. The message can be, for example, “Hazard ahead,” or “Accident ahead,” or “Traffic jam ahead,” or “Stopped vehicle ahead,” or “Construction ahead.”

Example 8—In an eighth example, a user can use the inter-vehicle communication system to communicate to another driver the regret for a transgression, such as accidently cutting in front of a vehicle. The message can be, for example, “Sorry” or “Apologies.” Such messages can help reduce occurrences of road rage by allowing drivers to apologize when they have offended other drivers.

Example 9—In a ninth example, a user can use the inter-vehicle communication system to communicate to another driver an impending traffic scenario. The message can be, for example, “Red light ahead,” or “Stop sign ahead,” or “Intersection ahead.”

Example 10—In a tenth example, a user can use the inter-vehicle communication system to communicate to another driver to stay back or move back. The message can be, for example, “Stay back,” or “Move back,” or “Keep distance,” or “10 ft. back.”

Example 11—In an eleventh example, a first responder or emergency personnel can use the inter-vehicle communication system to communicate to another driver. For example, the vehicle from which the message is communicated can be a police car, a fire truck, or an ambulance. The message can be, for example, “Pull over,” or “Move over,” or “Make way.”

### Applications

The systems and methods disclosed herein may be used to facilitate traffic flow, and to encourage a courteous traffic culture, or a “culture of yielding” in which drivers yield to other drivers in need of lane changes or other driving actions. As used herein a “culture of yielding” in traffic refers to civilized and polite attitudes, behaviors, and manners by drivers on the roadway, such as giving way to other drivers, apologizing to other drivers (e.g., if your vehicle bumps another vehicle), thanking other drivers for giving way, and stopping when appropriate (e.g., at a red light). As many of these actions are not spontaneous or habitual actions, the systems and methods disclosed herein may help facilitate these actions. While described in reference to use in traffic scenarios, the system disclosed herein may be implemented in other scenarios as well. For example, a store can incorporate a display of “Thank you” into the door to communicate appreciation to a customer as the customer leaves the store.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An inter-vehicle communication system for communicating messages from one vehicle to other vehicles, the system comprising:
a display configured to be positioned on a vehicle to present a message directed rearward of the vehicle;
wherein the message that the display is configured to present is a traffic-related communication.

2. The system of claim 1, wherein the display is configured to be coupled to a rearward portion of the vehicle.

3. (canceled)

4. (canceled)

5. (canceled)

6. The system of claim 1, wherein the message relates to a current status of traffic, an expected status of traffic, or a past status of traffic.

7. (canceled)

8. The system of claim 6, wherein the expected status of traffic includes a driving action expected to be taken by the vehicle.

9. (canceled)

10. The system of claim 6, wherein the past status of traffic includes a driving action previously taken by the vehicle.

11. The system of claim 1, wherein the message communicates gratitude or apologies to another driver; an intention to change lanes, stop, exit, brake, slow down, or turn; or a warning to other drivers.

12. (canceled)

13. (canceled)

14. (canceled)

15. The system of claim 11, wherein the warning is: hazard ahead; accident ahead, traffic jam ahead, stopped vehicle ahead, construction ahead; red light ahead; stop sign ahead; stay back; or intersection ahead.

16. (canceled)

17. (canceled)

18. The system of claim 1, wherein the message includes text, graphics, audio, or combinations thereof.

19. (canceled)

20. The system of claim 1, further comprising an input including a user interface configured to receive a user prompt to display the message and to generate and transmit a signal to the display to cause the display to present the message.

21. (canceled)

22. (canceled)

23. The system of claim 20, wherein the input comprises a graphical user interface; or wherein the input comprises a microphone and is voice-activated to generate and transmit the signal.

24. (canceled)

25. (canceled)

26. (canceled)

27. (canceled)

28. The system of claim 20, further comprising a central controller in communication with the input and the display, wherein the central controller is configured to receive the signal from the input, process the signal, and transmit the processed signal to the display.

29. The system of claim 28, wherein the central controller comprises a computer, a programmed logic controller, or a control platform.

30. A system for communicating messages to other vehicles, the system comprising:
a vehicle; and
a display on the vehicle positioned to present a message directed rearward of the vehicle;
wherein the message that the display is configured to present is a traffic-related communication.

31. (canceled)

32. (canceled)

33. The system of claim 30, wherein the vehicle is a car, truck, semi-trailer truck, van, or bus.

34. The system of claim 30, wherein the vehicle is a police vehicle, a fire truck, or an ambulance.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

48. (canceled)

49. (canceled)

50. (canceled)

51. (canceled)

52. The system of claim 30, wherein the display includes a rear windshield of the vehicle.

53. (canceled)

54. (canceled)

55. (canceled)

56. (canceled)

57. (canceled)

58. (canceled)

59. (canceled)

60. (canceled)

61. The system of claim 30, further comprising an input including a graphical user interface configured to receive a user prompt to display the message and to generate and transmit a signal to the display to cause the display to present the message, wherein the graphical user interface includes a navigation system of the vehicle.

62. (canceled)

63. (canceled)

64. (canceled)

65. (canceled)

66. The system of claim 30, wherein the vehicle is a self-driving vehicle, wherein the self-driving vehicle auto-imitates the message.

67. (canceled)

68. (canceled)

69. A method of inter-vehicular communication, the method comprising:
while in a first vehicle that is on a roadway, displaying a message on a display of the first vehicle, including presenting the message in a rearward direction from the first vehicle for view by a driver of a second vehicle on the roadway;
wherein presenting the message includes presenting a traffic-related communication.

70. The method of claim 69, wherein prior to displaying the message the first vehicle is in a first lane of the roadway and the second vehicle is in a second lane of the roadway that is adjacent the first lane; wherein after displaying the message the first vehicle is in the second lane and in front of the second vehicle; and wherein the message is an expression of gratitude or apologies for the first vehicle changing lanes in front of the second vehicle.

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)
